(19) United States
(12) Patent Application Publication
(10) Pub. No.: US 2022/0305772 A1
(43) Pub. Date: Sep. 29, 2022

(54) LIQUID EJECTING HEAD AND LIQUID EJECTING APPARATUS

(71) Applicant: SEIKO EPSON CORPORATION, Tokyo (JP)

(72) Inventor: Daisuke NAGANO, Matsumoto-shi (JP)

(21) Appl. No.: 17/656,704

(22) Filed: Mar. 28, 2022

(30) Foreign Application Priority Data
Mar. 29, 2021 (JP) 2021-054803

(51) Int. Cl. B41J 2/045; B41J 2/14

(52) U.S. Cl. CPC B41J 2/0451; B41J 2/14233; B41J 2/04581

(57) ABSTRACT

A liquid ejecting head that, as a piezoelectric actuator is driven, displaces a vibration plate between a first position where a pressure chamber contracts to the maximum degree and a second position where the pressure chamber expands to the maximum degree and ejects droplets from a nozzle, has a configuration in which, in an abnormal displacement state where the vibration plate exceeds the second position and is displaced to a third position and the displacement amount from a fourth position that is a center between the first position and the second position to the third position is twice or more of the displacement amount from the fourth position to the second position, pressure of a holding portion that is a sealing space is 1.05 times or more of the pressure of the holding portion when the vibration plate is at the second position.

The present application is based on, and claims priority from JP Application Serial Number 2021-054803, filed Mar. 29, 2021, the disclosure of which is hereby incorporated by reference herein in its entirety.

### BACKGROUND

### 1. Technical Field

The present disclosure relates to a liquid ejecting head and a liquid ejecting apparatus including a vibration plate on one surface side of a channel formation substrate having a pressure chamber, a piezoelectric actuator having a first electrode, a piezoelectric laminate, and a second electrode, and a protection substrate having a sealing space in which the piezoelectric actuator is sealed.

### 2. Related Art

As a typical example of a liquid ejecting head that is a type of a piezoelectric device is an ink jet recording head that ejects ink droplets. As a known example of the ink jet recording head is a recording head including a channel formation substrate, in which a pressure chamber communicating with a nozzle is formed, and a piezoelectric actuator provided on one surface side of the channel formation substrate via a vibration plate, in which the piezoelectric actuator generates a pressure change in ink inside the pressure chamber so as to eject ink droplets from the nozzle.

As the piezoelectric actuator, a piezoelectric element including a first electrode formed on a vibration plate, a piezoelectric laminate formed of a piezoelectric material having an electromechanical conversion property on the first electrode, and a second electrode provided on the piezoelectric laminate is known.

Moreover, some ink jet recording heads include a protection substrate for protecting such a piezoelectric element (for example, see JP-A-2020-32713). In JP-A-2020-32713, a configuration including a protection substrate installed on a side of a channel formation substrate opposite to a nozzle, in which a piezoelectric element is housed in a space between the channel formation substrate and the protection substrate, and this space is provided in each pressure chamber, is disclosed.

In an ink jet recording head as described above, when droplets are ejected as a piezoelectric actuator is driven, so-called abnormal displace, in which the displacement amount of a vibration plate excessively increases, may occur. For example, when bubbles are contained in ink that flows into a pressure chamber, due to unintended sympathetic vibration of the vibration plate, the displacement amount of the vibration plate to a side opposite to the pressure chamber may excessively increase.

After repetitively being in such an abnormal displacement state, the vibration plate fatigues and breakage such as a crack may occur in the vibration plate. Note that such breakage of the vibration plate easily occurs particularly at an end portion of the pressure chamber.

In addition, even in a case such as JP-A-2020-32713, in which a protection substrate for protecting the piezoelectric element is provided, deformation of the vibration plate is not substantially restricted. Therefore, the displacement amount of the vibration plate to the side opposite to the pressure chamber as described above excessively increases and breakage of the vibration plate may occur.

Note that such a problem is not limited to occurring in an ink jet recording head that ejects ink, and that problem occurs in a liquid ejecting head that ejects droplets other than ink as well.

### SUMMARY

According to an aspect of the present disclosure for solving the above-mentioned problem, a liquid ejecting head includes a channel formation substrate provided with a plurality of pressure chambers communicating with a nozzle, a vibration plate provided on one surface side of the channel formation substrate, a piezoelectric actuator provided on a surface of the vibration plate on a side opposite to the channel formation substrate and facing each of the plurality of pressure chambers, and having a piezoelectric laminate, and a first electrode and a second electrode sandwiching the piezoelectric laminate, and a protection substrate provided on one surface side of the channel formation substrate and including a recess, for the each pressure chamber, serving as a sealing space that seals the piezoelectric actuator inside, in which, as the piezoelectric actuator is driven, the vibration plate is displaced between a first position where the pressure chamber contracts to a maximum degree and a second position where the pressure chamber expands to a maximum degree, and droplets are ejected from the nozzle, and in an abnormal displacement state where the vibration plate exceeds the second position and is displaced to a third position, and a displacement amount from a fourth position that is a center between the first position and the second position to the third position is twice or more of a displacement amount from the fourth position to the second position, pressure of the sealing space is 1.05 times or more of pressure of the sealing space when the vibration plate is at the second position.

In addition, according to another aspect of the present disclosure, a liquid ejecting apparatus includes the above-mentioned liquid ejecting head.

### BRIEF DESCRIPTION OF THE DRAWINGS

FIG. 1 is a perspective exploded view of a recording head according to a first embodiment of the present disclosure.

FIG. 2 is a plan view of the recording head according to the first embodiment of the present disclosure.

FIG. 3 is a cross sectional view of the recording head according to the first embodiment of the present disclosure.

FIG. 4 is a cross sectional view of the recording head according to the first embodiment of the present disclosure.

FIG. 5 is a schematic diagram illustrating a displacement state of a vibration plate.

FIG. 6 is a schematic diagram illustrating a displacement state of the vibration plate.

FIG. 7 is a graph illustrating a relationship between a fourth position and a height of a holding portion at which a pressure ratio is 1.05.

FIG. 8 is a graph illustrating a relationship between amplitude of the vibration plate and a height of the holding portion at which the pressure ratio is 1.05.

FIG. 9 is a cross sectional view of a recording head according to a second embodiment of the present disclosure.

FIG. 10 is a cross sectional view of a recording head according to a third embodiment of the present disclosure.

FIG. 11 is a cross sectional view of a recording head according to a fourth embodiment of the present disclosure.

FIG. 12 is a cross sectional view of a recording head according to a fifth embodiment of the present disclosure.

FIG. 13 is a view illustrating a schematic configuration of a recording apparatus according to the first embodiment of the present disclosure.

### DESCRIPTION OF EXEMPLARY EMBODIMENTS

Hereinafter, the present disclosure will be described in details based on embodiments. However, the following description is a description of one aspect of the present disclosure, and the configuration of the present disclosure can be appropriately changed within the scope of the disclosure. In each figure, the same members are denoted by the same reference numerals, and redundant descriptions are omitted.

In addition, in each figure, X, Y, and Z represent three spatial axes that are orthogonal to each other. In the present specification, directions extending in these axes are X-axis, Y-axis, and Z-axis. The description will be given considering that the direction toward which the arrow extends in each figure is a positive (+) direction and the opposite direction of the arrow is a negative (−) direction. Moreover, the Z-axis indicate the vertical direction, the +Z-direction indicates vertically downward, and the −Z direction indicates vertically upward. Furthermore, the description will be given considering that the three spatial axes of X, Y and Z to which the positive and negative directions are not limited are the X-axis, the Y-axis, and the Z-axis.

### First Embodiment

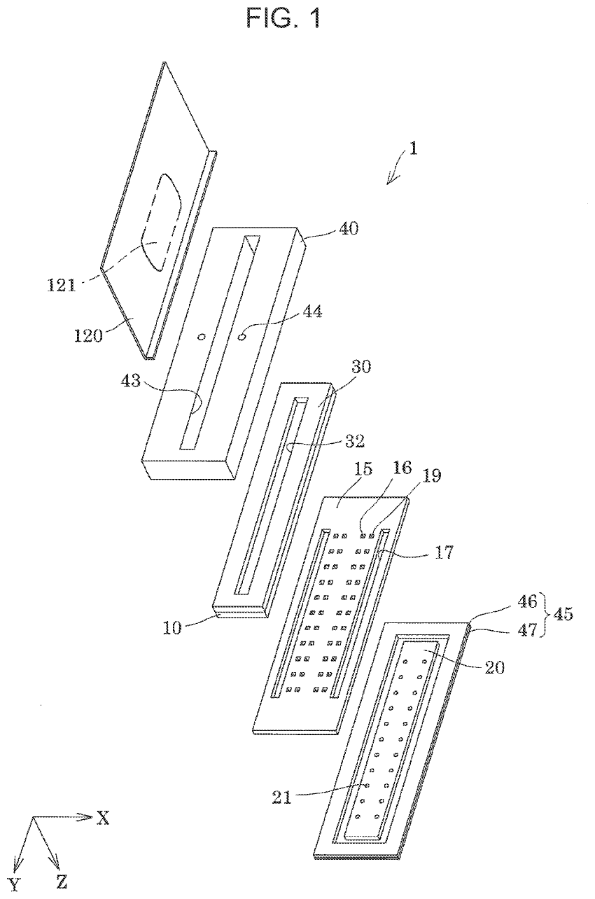

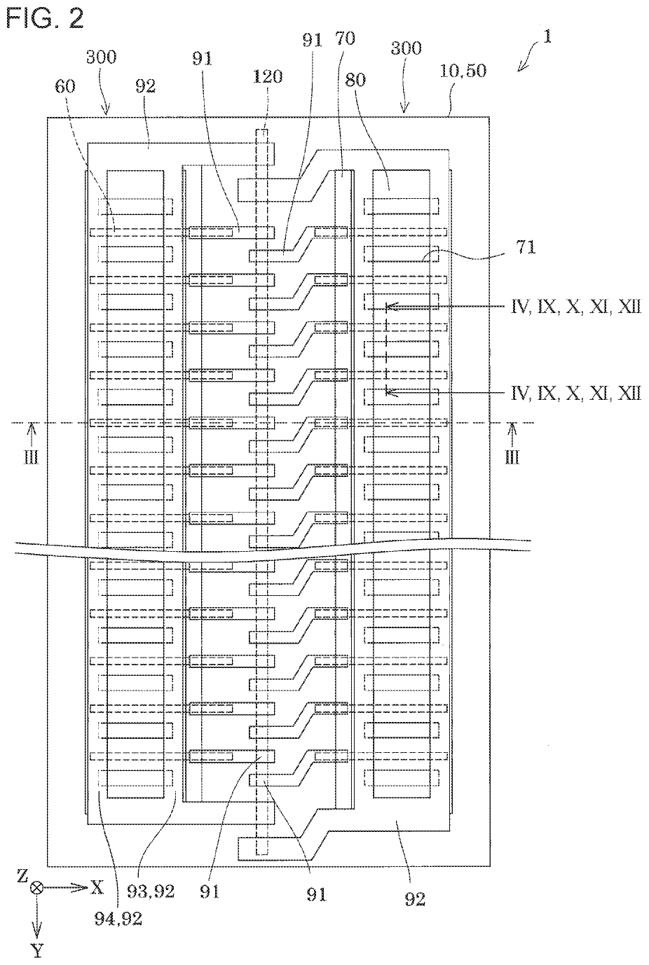

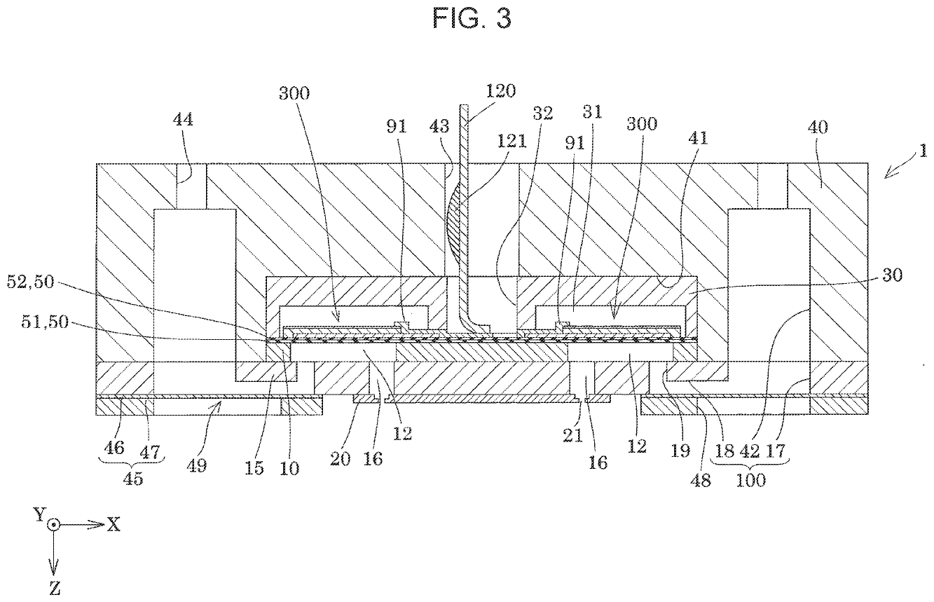

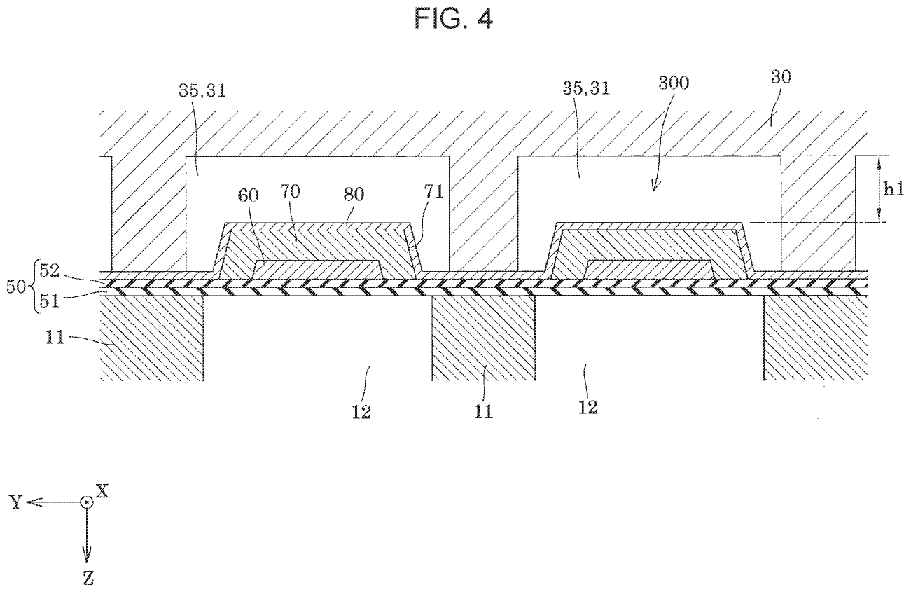

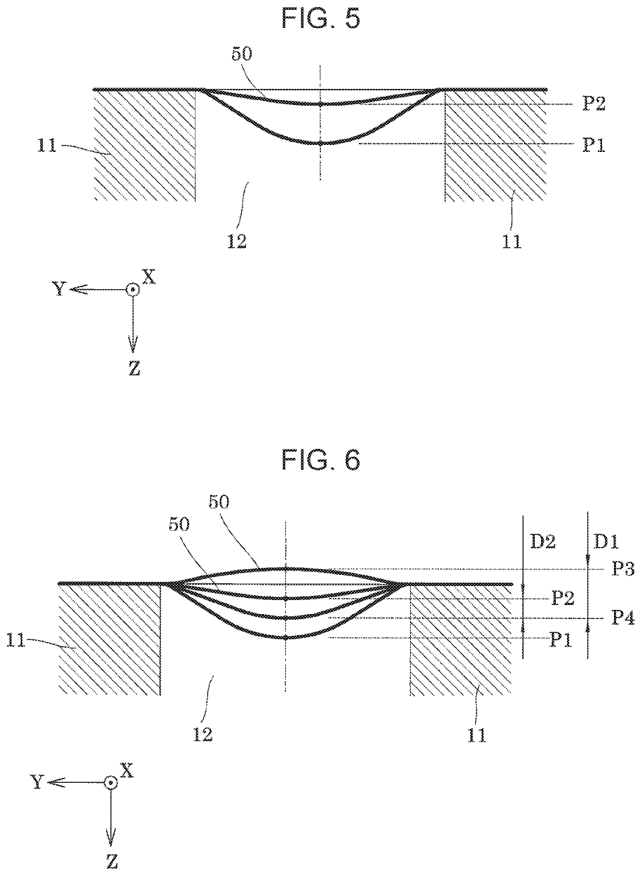

FIG. 1 is an exploded perspective view of an ink jet recording head as an example of a liquid ejecting head according to a first embodiment of the present disclosure. FIG. 2 is a plan view of the recording head. FIG. 3 is a cross sectional view taken along line III-III of FIG. 2. FIG. 4 is a cross sectional view taken along line IV-IV of FIG. 2. In addition, FIGS. 5 and 6 are schematic diagrams illustrating displacement states of a vibration plate.

As illustrated, an ink jet recording head (hereinafter, also simply referred to as “recording head”) 1, which is an example of a liquid ejecting head of the present embodiment, ejects ink droplets in the Z-axis direction, more specifically, in the +Z-direction.

The ink jet recording head 1 includes a channel formation substrate 10, in which a liquid channel through which ink flows is formed. For example, the channel formation substrate 10 consists of a silicon substrate, a glass substrate, a silicon on insulator (SOI) substrate, various ceramic substrates, and the like. Note that the channel formation substrate 10 may be a substrate preferentially oriented on a (100) plane or a substrate preferentially oriented on a (110) plane.

On the channel formation substrate 10, a plurality of pressure chambers 12 that forms a liquid channel is disposed in two rows in the X-axis direction that intersects with the Z-axis direction. That is, the plurality of pressure chambers 12 that constitutes each column is disposed in the Y-axis direction that intersects with the X-axis direction.

The plurality of pressure chambers 12 that constitutes each column is disposed on a straight line extending in the Y-axis direction so as to be at the same position in the X-axis direction. The pressure chambers 12 adjacent to each other in the Y-axis direction are divided by partition walls 11. Needless to say, the arrangement of the pressure chambers 12 is not particularly limited. For example, the plurality of pressure chambers 12 arranged in the Y-axis direction may be arranged in so-called zigzag, in which each pressure chamber 12 alternatively deviates in the X-axis direction.

In addition, the pressure chamber 12 of the present embodiment is formed into, for example, a rectangle whose the length in the X-axis direction in plan view from the +Z-axis direction side is longer than the length in the Y-axis direction. Needless to say, the shape of the pressure chamber 12 in plan view from the +Z-axis direction is not particularly limited and may be a parallelogram, a polygonal shape, a circular shape, an oval shape, or the like. Note that the ovel shape here is a shape that has a semi-circular shape based on a rectangular shape at each end in the longitudinal direction and includes a rounded rectangular shape, an elliptic shape, an egg shape, and the like.

In the +Z-axis direction of the channel formation substrate 10, a communicating plate 15, a nozzle plate 20, and a compliance substrate 45 are sequentially laminated.

The communicating plate 15 is provided with a nozzle communicating passage 16 that communicates with the pressure chamber 12 and a nozzle 21. In addition, the communicating plate 15 is provided with a first manifold portion 17 and a second manifold portion 18, which constitute a part of a manifold 100 that becomes a common liquid chamber, in which the plurality of the pressure chambers 12 communicates. The first manifold portion 17 is provided so as to penetrate the communicating plate 15 in the Z-axis direction. In addition, the second manifold portion 18 is provided so as to open on a surface on the +Z-axis side without penetrating the communicating plate 15 in the Z-axis direction.

In addition, in the communicating plate 15, in each pressure chamber 12, a supply communicating passage 19 that communicates with one end portion of the pressure chamber 12 in the X-axis direction is independently provided. The supply communicating passage 19 communicates the second manifold portion 18 with each pressure chamber 12 so as to supply ink in the manifold 100 to each pressure chamber 12.

As the communicating plate 15, a silicon substrate, a glass substrate, an SOI substrate, various ceramic substrates, a metal substrate, and the like may be used. Examples of the metal substrate include a stainless steel substrate. Note that, for the communicating plate 15, a material whose thermal expansion coefficient is substantially the same as that of the channel formation substrate 10 is preferably used. As a result, when temperatures of the channel formation substrate 10 and the communicating plate 15 change, the channel formation substrate 10 and the communicating plate 15 can be suppressed from warping caused by the difference in thermal expansion coefficient.

The nozzle plate 20 is provided on a side opposite to the channel formation substrate 10, that is, on a surface on the +Z-axis side of the communicating plate 15. On the nozzle plate 20, the nozzle 21 that communicates with each pressure chamber 12 through the communicating passage 16 is formed.

In the present embodiment, a plurality of the nozzles 21 is arranged to form a line in the Y-axis direction. In the nozzle plate 20, two nozzle rows, each of which has the plurality of nozzles 21 provided in a column, are provided in the X-axis direction. That is, the plurality of nozzles 21 in each column is disposed so as to be at the same position in the X-axis. Note that the arrangement of the nozzles 21 is not particularly limited. For example, the nozzles 21 arranged in the Y-axis direction may be arranged in such a manner that the nozzles 21 alternatively deviate in the X-axis direction.

A material of the nozzle plate 20 is not particularly limited and, for example, a silicon substrate, a glass substrate, an SOI substrate, various ceramic substrates, a metal substrate, and the like may be used. Examples of the metal substrate include a stainless steel substrate. Moreover, as a material of the nozzle plate 20, an organic matter such as a polyimide resin and the like may also be used. However, for the nozzle plate 20, a material whose thermal expansion coefficient is substantially the same as that of the communicating plate 15 is preferably used. As a result, when temperatures of the nozzle plate 20 and the communicating plate 15 change, the nozzle plate 20 and the communicating plate 15 can be suppressed from warping caused by the difference in thermal expansion coefficient.

The compliance substrate 45 is provided, together with the nozzle plate 20, on the side opposite to the channel formation substrate 10, that is, on a surface on the +Z-axis side of the communicating plate 15. The compliance substrate 45 is provided around the nozzle plate 20 and seals the openings of the first manifold portion 17 and the second manifold portion 18 provided in the communicating plate 15. In the present embodiment, the compliance substrate 45 includes a sealing film 46 formed of a flexible thin film and a fixing substrate 47 made of a hard material such as metal. The area of the fixing substrate 47 facing the manifold 100 is an opening portion 48 that is completely removed in the thickness direction. Therefore, one surface of the manifold 100 is a compliance portion 49 that is sealed by the flexible sealing film 46 only.

On the other hand, on the side opposite to the nozzle plate 20 and the like, that is, on the surface on the −Z-axis side of the channel formation substrate 10, as will be described in details later, a vibration plate 50 and a piezoelectric actuator 300 that bends and deforms the vibration plate 50 to cause a pressure change in ink in the pressure chamber 12 are provided.

Moreover, on the surface on the −Z-axis side of the channel formation substrate 10, a protection substrate 30 that is substantially as large as the channel formation substrate 10 is bonded with an adhesive or the like. The piezoelectric actuator 300 is housed in a holding portion 35 that is a sealing space formed between the channel formation substrate 10 and the protection substrate 30.

In the present embodiment, the protection substrate 30 is provided with a recess 31 that forms the holding portion 35. As illustrated in FIG. 4, the recess 31 is independently provided for each of the piezoelectric actuators 300, which is arranged in the Y-axis direction, formed and disposed in two rows in the X-axis direction. The recess 31 is provided while opening on the surface of the channel formation substrate 10 side of the protection substrate 30 and sealed by the channel formation substrate 10. As a result, the holding portion 35 that is a sealing space, in which the piezoelectric actuators 300 is housed, is formed.

In addition, the shape of the recess 31 may be appropriately determined, and in the present embodiment, similarly to the pressure chamber 12, the recess 31 is formed into a rectangle whose length in the X-axis direction is longer than length in the Y-axis direction in plan view from the +Z-axis direction. The size of the recess 31 may be appropriately determined, and in the present embodiment, the length in the X-axis direction is 400 μm, and the length in the Y-axis direction is 70 μm.

In addition, the protection substrate 30 is provided with a through hole 32 that penetrates the protection substrate 30 in the Z-axis direction between columns of the recesses 31. A wiring substrate 120 described later is inserted into the through hole 32.

On the protection substrate 30, a case member 40 that defines, together with the channel formation substrate 10, the manifold 100 communicating with the plurality of pressure chambers 12 is fixed. The case member 40 has the substantially same shape as the communicating plate 15 described above in plan view, is bonded to the protection substrate 30 and also bonded to the communicating plate 15 described above.

In the case member 40, a housing portion 41 that is a recess deep enough to house the channel formation substrate 10 and the protection substrate 30 is provided while opening on a surface on the protection substrate 30 side. The housing portion 41 has an opening area that is wider than the surface of the protection substrate 30 bonded to the channel formation substrate 10. In addition, with the channel formation substrate 10 and the protection substrate 30 being housed in the housing portion 41, the opening surface of the housing portion 41 on the nozzle plate 20 side is sealed by the communicating plate 15.

Moreover, in the case member 40, a third manifold portion 42 is formed on each outer side of the housing portion 41 in the X-axis direction. The first manifold portion 17 and the second manifold portion 18 provided in the communicating plate 15 and the third manifold portion 42 constitute the manifold 100 of the present embodiment. The manifold 100 is continuously provided in the Y-axis direction, and the supply communicating passages 19, each of which communicates each pressure chamber 12 with the manifold 100, are arranged in a line in the Y-axis direction.

In addition, in the case member 40, an outlet 44 that communicates with the manifold 100 to supply ink to each manifold 100 is provided. Moreover, in the case member 40, a coupling port 43 communicating with the through hole 32 of the protection substrate 30, into which the wiring substrate 120 is inserted, is provided.

Next, the configuration of the piezoelectric actuator 300 will be described. As described above, the piezoelectric actuator 300 is provided, via the vibration plate 50, on a surface of the channel formation substrate 10 on a side opposite to the nozzle plate 20.

The vibration plate 50 is constituted by an elastic film 51 made of silicon oxide provided on the channel formation substrate 10 side, and an insulating film 52 made of a zirconium oxide film provided on the elastic film 51. A liquid channel such as the pressure chamber 12 is formed by performing anisotropic etching on the channel formation substrate 10 from the surface on the +Z-axis direction side, and the surface of the liquid channel such as the pressure chamber 12 on the −Z-axis direction side is constituted by the elastic film 51. The thickness of the vibration plate 50 may be appropriately determined, and in the present embodiment, the thickness of the elastic film 51 is 1.0 μm, and the thickness of the insulating film 52 is 0.65 μm.

Note that the configuration of the vibration plate 50 is not particularly limited. The vibration plate 50 may be, for example, constituted by one of the elastic film 51 and the insulating film 52, and, moreover, may include a film other than the elastic film 51 and the insulating film 52. Examples of a material of the film other than the elastic film 51 and the insulating film 52 include silicon, silicon-nitrogen, and the like.

The piezoelectric actuator 300 is a pressure generating unit that generates a pressure change in ink in the pressure chamber 12 and is also called a piezoelectric element. The piezoelectric actuator 300 includes a first electrode 60, a piezoelectric laminate 70, and a second electrode 80 that are sequentially laminated toward the −Z-axis direction side from the +Z-axis direction side, which is the vibration plate 50 side. This means that, in the Z-axis direction, which is the first direction with respect to the vibration plate 50, in the present embodiment, the piezoelectric actuator 300 includes the first electrode 60, the piezoelectric laminate 70, and the second electrode 80 that are sequentially laminated toward the −Z-axis direction side.

In the piezoelectric actuator 300, a portion, in which piezoelectric distortion is generated in the piezoelectric laminate 70 when a voltage is applied between the first electrode 60 and the second electrode 80, is called an active portion. On the other hand, a portion, in which piezoelectric distortion is not generated in the piezoelectric laminate 70, is called an inactive portion. That is, in the piezoelectric actuator 300, the portion of the piezoelectric laminate 70 sandwiched by the first electrode 60 and the second electrode 80 is the active portion, and the portion of the piezoelectric laminate 70 not sandwiched by the first electrode 60 and the second electrode 80 is the inactive portion.

In general, either one of electrodes of the active portion is configured as an individual electrode that is independent for each active portion, and another electrode is configured as a common electrode that is common to a plurality of active portions. In the present embodiment, the first electrode 60 configures the individual electrode and the second electrode 80 configures the common electrode.

The material of the first electrode 60 is not particularly limited, and, for example, metal such as iridium and platinum or a conductive material such as conductive metal oxide and the like including indium oxide-tin abbreviated as ITO is used. The thickness of the first electrode 60 may be appropriately determined and is, for example, appropriately 0.1 μm.

The piezoelectric laminate 70 is made of a piezoelectric material of an oxide having a polarization structure formed on the first electrode 60 and can be made of, for example, a perovskite-type oxide expressed by general formula ABO₃. As the perovskite-type oxide used for the piezoelectric laminate 70, for example, a lead-based piezoelectric material containing lead and a non-lead-based piezoelectric material not containing lead can be used. Moreover, the thickness of the piezoelectric laminate 70 is not particularly limited, but is preferably 0.1 μm to 5 μm, and is 1 μm in the present disclosure.

In addition, as illustrated in FIG. 2, the piezoelectric laminate 70 is continuously provided in the Y-axis direction while the length in the X-axis direction is set to a predetermined length. This means that the piezoelectric laminate 70 having a predetermined thickness is continuously provided in the arrangement direction of the pressure chambers 12.

Moreover, in the piezoelectric laminate 70, as illustrated in FIGS. 2 and 4, a groove portion 71 that is a portion thinner than other areas is formed corresponding to each partition wall 11. The groove portion 71 of the present embodiment is formed by completely removing the piezoelectric laminate 70 in the Z-axis direction. That is, the piezoelectric laminate 70 having a portion thinner than other areas includes the piezoelectric laminate 70 having a portion completely removed in the Z-axis direction. Needless to say, the piezoelectric laminate 70 may be formed be thinner than other portions at the bottom surface of the groove portion 71.

The second electrode 80 is provided on the −Z-axis direction side, which is a side of the piezoelectric laminate 70 opposite to the first electrode 60, and constitutes a common electrode that is common to a plurality of active portions. The second electrode 80 is continuously provided in the Y-axis direction while the length in the X-axis direction is set to a predetermined length. The thickness of the second electrode 80 is not particularly limited and is, for example, approximately 50 nm.

In addition, an individual lead electrode 91 and a common lead electrode 92, which is a common driving electrode, are coupled to the first electrode 60 and the second electrode 80 that constitute the piezoelectric actuator 300, respectively. The flexible wiring substrate 120 is coupled to the end portions of the individual lead electrode 91 and the common lead electrode 92 on a side opposite to the end portions coupled to the piezoelectric actuator 300. In the present embodiment, the individual lead electrode 91 and the common lead electrode 92 extend so as to be exposed in the through hole 32 formed in the protection substrate 30 and is electrically coupled to the wiring substrate 120 in the through hole 32. On the wiring substrate 120, a driving circuit 121 having a switching element for driving the piezoelectric actuator 300 is mounted.

The material of the individual lead electrode 91 and the common lead electrode 92 is not particularly limited as long as being conductive, and for example, gold (Au), platinum (Pt), aluminum (Al), copper (Cu), and the like can be used. In addition, the thickness of the individual lead electrode 91 and the common lead electrode 92 is not particularly limited and is, for example, approximately 1 μm.

In the recording head 1 of the present embodiment described above, after ink is taken from the outlet 44 coupled to an external ink supply unit (not illustrated), and the inside from the manifold 100 to the nozzles 21 is filled with the ink, a voltage is applied to each piezoelectric actuator 300 corresponding to the pressure chamber 12 according to a recording signal from the driving circuit 121, as a result of which the vibration plate 50 is bent and deformed together with the piezoelectric actuator 300, the pressure in each pressure chamber 12 increases, and ink droplets are ejected from each nozzle 21.

Here, how the vibration plate 50 displaces as the piezoelectric actuator 300 is driven will be described. The vibration plate 50 according to the present embodiment is slightly bent as a protrusion on the pressure chamber 12 side when the piezoelectric actuator 300 is not driven. After the voltage is applied to piezoelectric actuator 300, the vibration plate 50 is displaced from this state. Specifically, as illustrated in the schematic diagram of FIG. 5, the vibration plate 50 displaces in the Z-axis direction between a first position P1 where the pressure chamber 12 contracts to the maximum degree and a second position P2 where the pressure chamber 12 expands to the maximum degree. As a result, ink droplets are ejected from the nozzle 21.

By the way, the holding portion 35, in which the piezoelectric actuator 300 is housed as described above, is a sealing space that is shielded from the outside air. Therefore, the pressure inside the holding portion 35 changes as the vibration plate 50 displaces. That is, the pressure inside the holding portion 35 decreases as the vibration plate 50 displaces toward the pressure chamber 12 side and increases as the vibration plate 50 displaces toward a side opposite to the pressure chamber 12 side.

When ink droplets are ejected as the piezoelectric actuator 300 is normally driven, that is, when the vibration plate 50 is in a normal displacement state, the vibration plate 50 displaces between the first position P1 and the second position P2 as described above. Therefore, when the vibration plate 50 is in the normal displacement state, the pressure inside the holding portion 35 is the lowest when the vibration plate 50 displaces to the first position P1, and is the highest when the vibration plate 50 displaces to the second position P2.

However, for example, when bubbles are contained in the ink that flows into the pressure chamber 12, due to unintended sympathetic vibration of the vibration plate 50, the vibration plate 50 may excessively displace to the side opposite to the pressure chamber 12 and exceed the second position P2. That is, the vibration plate 50 may be in an abnormal displacement state, in which the vibration plate 50 displaces exceeding a boundary where the vibration plate 50 is in the normal displacement state.

Here, specifically, the abnormal displacement state is, as illustrated in the schematic diagram of FIG. 6, a state in which the vibration plate 50 exceeds the second position P2 and displaces to a third position P3 in the −Z-axis direction, and a displacement amount D1 from a fourth position P4, which is the middle point between the first position P1 and the second position P2, to the third position P3 in the Z-axis direction is twice or more of a displacement amount D2 from the fourth position P4 to the second position P2.

The recording head 1 is configured such that the pressure inside the holding portion 35 when the vibration plate 50 is in such an abnormal displacement state is 1.05 times or more of the maximum pressure inside the holding portion 35 when the vibration plate 50 is in the normal displacement state. That is, the recording head 1 is configured such that the pressure inside the holding portion 35 when the vibration plate 50 is at the third position P3 is 1.05 times or more of the pressure of the holding portion 35 when the vibration plate 50 is at the second position P2. In addition, the pressure of the holding portion 35 in the abnormal displacement state may be 1.05 times or more of the maximum pressure inside the holding portion 35 when the vibration plate 50 is in the normal displacement position, but is more preferably 1.1 times or more.

Accordingly, when the vibration plate 50 is in the abnormal displacement state as the piezoelectric actuator 300 is driven, gas (for example, air) inside the holding portion 35, which is a sealing space, functions as a damper and suppresses the vibration plate 50 and the piezoelectric actuator 300 from excessively displacing. As a result, breakage of the vibration plate 50 and the piezoelectric actuator 300 is suppressed. For example, breakage such as a crack in the vibration plate 50 after the vibration plate 50 fatigues due to repetitively being in the abnormal displacement state can be suppressed.

Breakage of the vibration plate 50 easily occurs near an end portion of the pressure chamber 12 in the Y-axis direction, but since the recording head 1 has the above-mentioned configuration, breakage of the vibration plate 50 near the end portion of the pressure chamber 12 can be effectively suppressed.

When the displacement of the vibration plate 50 in the abnormal displacement state is relatively large, in particular, when the third position P3, at which the vibration plate 50 is bent as a protrusion on the protection substrate 30 side, is on the protection substrate 30 side from the surface of the channel formation substrate 10 in the Z-axis direction, breakage of the vibration plate 50 and the piezoelectric actuator 300 can be more effectively suppressed.

Note that the pressure inside the holding portion 35 needs to be appropriately adjusted according to the displacement characteristics and the like of the vibration plate 50. That is, the pressure inside the holding portion 35 needs to be appropriately adjusted according to the displacement characteristics and the like of the vibration plate 50 so that a ratio Pa/Pb (hereinafter, referred to as a pressure ratio) of pressure Pb inside the holding portion 35 when the vibration plate 50 is at the third position P3 with respect to pressure Pa of the holding portion 35 when the vibration plate 50 is at the second position P2 becomes equal to or more than 1.05.

The adjustment method of the pressure inside the holding portion 35 is not particularly limited. That is, the adjustment method of the above-mentioned pressure ratio is not particularly limited. The pressure ratio can be, for example, appropriately adjusted by the height of the holding portion 35. This means that the pressure inside the holding portion 35 can be appropriately adjusted by the height of the holding portion 35.

The height of the holding portion 35 is the height of a portion of the holding portion 35 corresponding to the piezoelectric actuator 300 and is a height h1 from the piezoelectric actuator 300 to the protection substrate 30 (see FIG. 4). Note that, in the present embodiment, the inner surface of the recess 31 that forms the holding portion 35 has a rectangular shape in a cross sectional view in the Y-axis direction, and the holding portion 35 is formed at the fixed height h1 in the Y-axis direction.

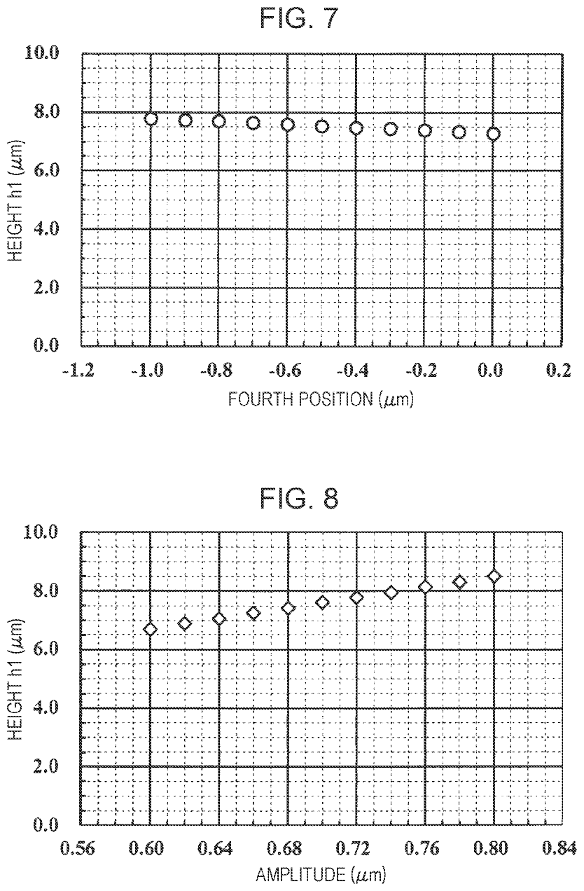

FIG. 7 is a graph illustrating a relationship between the fourth position P4, which is the middle point between the first position P1 and the second position P2 in the Z-axis direction, and the height h1 of the holding portion 35 when the above-mentioned pressure ratio is 1.05. Note that, in this graph, the fourth position P4 is expressed by a distance from the surface of the channel formation substrate 10 in the −Z-axis direction while the holding portion 35 side is set to a plus direction and the pressure chamber 12 side is set to a minus direction.

As is evident from FIG. 7, as the fourth position P4 advances on the pressure chamber 12 side, the height h1 of the holding portion 35, at which the pressure ratio is 1.05, tends to increase. Therefore, by appropriately adjusting the height h1 of the holding portion 35 according to the fourth position P4 of the vibration plate 50, regardless of the fourth position P4 of the vibration plate 50, the pressure ratio can be adjusted to equal to or more than 1.05. That is, by appropriately adjusting the height h1 of the holding portion 35, regardless of the fourth position P4 of the vibration plate 50, the pressure inside the holding portion 35 when the vibration plate 50 is at the third position P3 can be made 1.05 times or more of the pressure of the holding portion 35 when the vibration plate 50 is at the second position P2.

FIG. 8 is a graph illustrating a relationship between a displacement amount (hereinafter, referred to as amplitude) of the vibration plate 50 from the fourth position P4 to the second position P2 and the height h1 of the holding portion 35 when the above-mentioned pressure ratio is 1.05. As is evident from this graph, as the amplitude of the vibration plate 50 increases, the height h1 of the holding portion 35, at which the pressure ratio is 1.05, tends to increase. Therefore, by appropriately adjusting the height h1 of the holding portion 35 according to the amplitude of the vibration plate 50, regardless of the amplitude of the vibration plate 50, the pressure ratio can be adjusted to equal to or more than 1.05. That is, by appropriately adjusting the height h1 of the holding portion 35, regardless of the amplitude of the vibration plate 50, the pressure inside the holding portion 35 when the vibration plate 50 is at the third position P3 can be made 1.05 times or more of the pressure of the holding portion 35 when the vibration plate 50 is at the second position P2.

As described above, the recording head 1 according to the present embodiment is configured such that the pressure inside the holding portion 35 when the vibration plate 50 is in the abnormal displacement state is equal to or more than 1.05 of the maximum pressure inside the holding portion 35 when the vibration plate 50 is in the normal displacement state. As a result, even when the vibration plate 50 is in the abnormal displacement state, breakage of the vibration plate 50 and the piezoelectric actuator 300 can be suppressed. For example, fatigue of the vibration plate 50 due to repetitively being in the abnormal displacement state can be reduced, and breakage such as a crack in the vibration plate 50 can be suppressed from occurring.

By the way, the height h1 of the holding portion 35 may be appropriately set within a range where driving of the piezoelectric actuator 300 is not hindered, but is preferably equal to or less than 10 μm, and is more preferably equal to or less than 4 μm. As a result, in the recording head 1 including the piezoelectric actuator 300 including the first electrode 60, the piezoelectric laminate 70, and the second electrode 80 described above, the pressure inside the holding portion 35 when the vibration plate 50 is in the abnormal displacement state can be more reliably made 1.05 times or more of the maximum pressure inside the holding portion 35 when the vibration plate 50 is in the normal displacement state.

In addition, in the present embodiment, the vibration plate 50 is bent as a protrusion on the pressure chamber 12 side when the piezoelectric actuator 300 is not driven. As a result, even when the vibration plate 50 is in the abnormal displacement state, breakage of the vibration plate 50 can be more reliably suppressed. Needless to say, the vibration plate 50 does not have to be bent as a protrusion on the pressure chamber 12 side when the piezoelectric actuator 300 is not driven.

In addition, the pressure of the holding portion 35 may be set so that the above-mentioned pressure ratio is equal to or more than 1.05, and for example, the pressure of the holding portion 35 when the piezoelectric actuator 300 is not driven is not particularly limited. However, the pressure of the holding portion 35 when the piezoelectric actuator 300 is not driven is preferably higher than 1 atmospheric pressure. As a result, the damper effect by the holding portion 35 increases and breakage of the vibration plate 50 and the like can be more reliably suppressed.

In addition, in the present embodiment, since the groove portion 71 is provided in the piezoelectric laminate 70, when the protection substrate 30 is bonded to the channel formation substrate 10, outflow of an adhesive can be easily coped with. Accordingly, when the recording head 1 is manufactured, the height h1 of the holding portion 35 can be easily adjusted.

Moreover, since the recess 31, which becomes the holding portion 35, is formed into a rectangle whose length in the X-axis direction is longer than the length in the Y-axis direction, the nozzle resolution can be easily increased, and breakage of the vibration plate 50 and the piezoelectric actuator 300 can be easily suppressed by the damper effect of the holding portion 35.

### Test Example

Here, 100 recording heads for each of comparative examples 1 and 2 and examples 1 to 4, in which the recording head has the same configuration except for changing the above-mentioned pressure ratio by the height h1 of the holding portion, have been manufactured, and the number of recording heads in which breakage of the vibration plate has occurred when the vibration plate was in the abnormal displacement state has been examined. The result is shown in a table 1 below.

TABLE 1

| | Comparative | Comparative | | | | |
|---|---|---|---|---|---|---|
| | example 1 | example 2 | Example 1 | Example 2 | Example 3 | Example 4 |
| Pressure ratio | 1.0 | 1.03 | 1.05 | 1.1 | 1.2 | 1.6 |
| Height h1 (μm) | 50 | 30 | 10 | 4 | 2 | 1 |
| Number of recording | 5/100 | 4/100 | 1/100 | 0/100 | 0/100 | 0/100 |
| heads in which | | | | | | |
| breakage of vibration | | | | | | |
| plate occurs | | | | | | |

As the Table 1 shows, breakage of the vibration plate was confirmed in a plurality of the recording heads of the comparative examples 1 and 2, in which the pressure ratio is less than 1.05. On the other hand, almost no breakage of the vibration plate has occurred in the recording heads 1 of the examples 1 to 4, in which the pressure ratio is equal to or more than 1.05. In particular, no breakage of the vibration plate has occurred in the examples 2 to 4, in which the pressure ratio is equal to or more than 1.1.

As is evident from the result, by making the pressure of the holding portion 35 in the abnormal displacement state 1.05 times or more of the pressure of the holding portion 35 when the vibration plate 50 is at the second position P2, even when the vibration plate 50 is in the abnormal displacement state, breakage of the vibration plate 50 and the piezoelectric actuator 300 can be suppressed.

### Second Embodiment

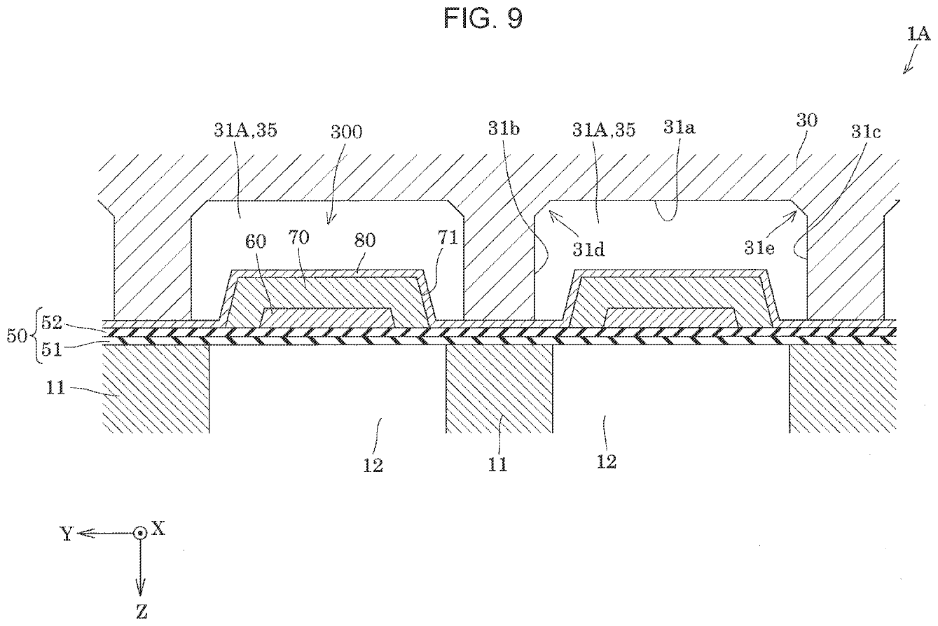

FIG. 9 is a cross sectional view of a recording head according to a second embodiment and is a cross sectional view taken along line IX-IX of FIG. 2. Note that the same members are denoted by the same reference numerals, and redundant descriptions are omitted.

In a recording head 1A according to the present embodiment, the shape of a recess 31A formed by the protection substrate 30 is a modification of the shape of the holding portion 35, which is a sealing space, and the configuration other than the shape of the recess 31A is the same as the configuration of the first embodiment.

As illustrated in FIG. 9, in the present embodiment, the inner surface of the recess 31A formed by the protection substrate 30 has a polygonal shape in a cross sectional view in the Y-axis direction, which is the arrangement direction of the pressure chambers 12. Specifically, in the cross sectional view in the Y-axis direction, the recess 31A is constituted by multiple surfaces including surfaces in addition to an upper surface 31a and two side surfaces 31b and 31c. That is, the recess 31A is constituted by five surfaces of the upper surface 31a, the two side surfaces 31b and 31c, a coupling surface 31d provided between the upper surface 31a and the side surface 31b, and a coupling surface 31e provided between the upper surface 31a and the side surface 31c. Note that the coupling surfaces 31d and 31e are inclined with respect to the upper surface 31a and the side surfaces 31b and 31c.

In the recording head 1A having such a configuration as well, the pressure inside the holding portion 35 when the vibration plate 50 is in the abnormal displacement state is 1.05 times or more of the maximum pressure inside the holding portion 35 when the vibration plate 50 is in the normal displacement state, as a result of which, even when the vibration plate 50 is in the abnormal displacement state, breakage of the vibration plate 50 and the piezoelectric actuator 300 can be suppressed.

In addition, the inner surface of the recess 31A, which becomes the holding portion 35, has a polygonal shape as described above, as a result of which, when the vibration plate 50 is in the abnormal displacement state, the pressure inside the holding portion 35 easily increases. Accordingly, even when the vibration plate 50 is in the abnormal displacement state, breakage of the vibration plate 50 and the piezoelectric actuator 300 can be more reliably suppressed. Moreover, since the rigidity of the protection substrate 30 corresponding to the wall portion of the holding portion 35 is enhanced, breakage of the protection substrate 30 due to stress in a bonding process can be suppressed.

### Third Embodiment

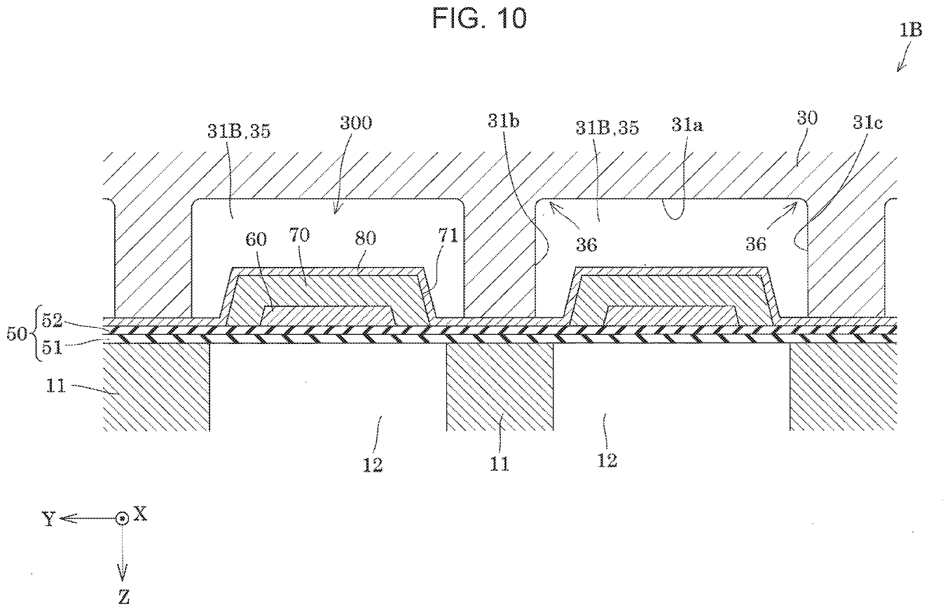

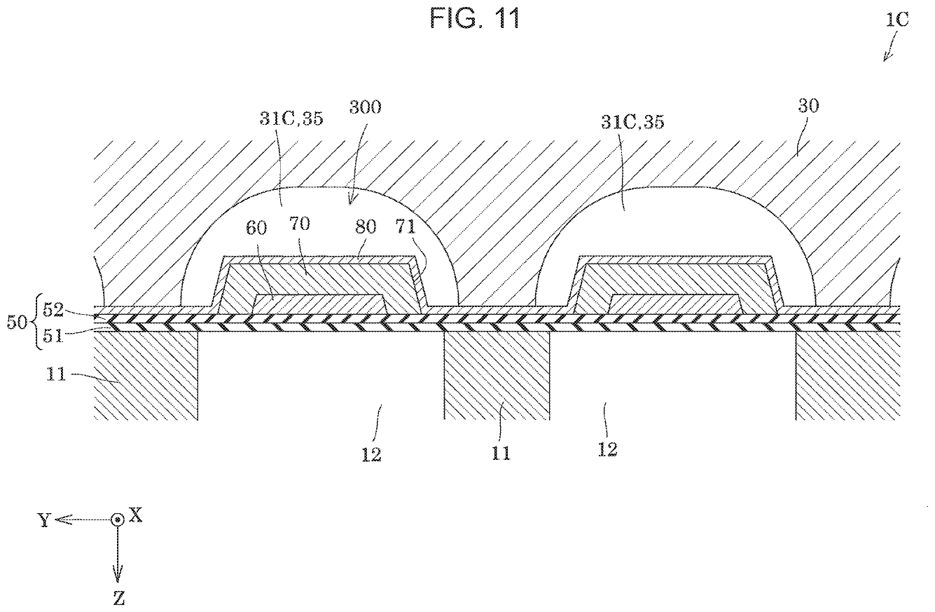

FIG. 10 is a cross sectional view of a recording head according to a third embodiment and is a cross sectional view taken along line X-X of FIG. 2. Note that the same members are denoted by the same reference numerals, and redundant descriptions are omitted.

In a recording head 1B according to the present embodiment as well, the shape of a recess 31B formed by the protection substrate 30 is a modification of the shape of the holding portion 35, which is a sealing space, and the configuration other than the shape of the recess 31B is the same as the configuration of the first embodiment.

As illustrated in FIG. 10, in the present embodiment, the inner surface of the recess 31B formed by the protection substrate 30 includes a curve in a cross sectional view in the Y-axis direction, which is the arrangement direction of the pressure chambers 12, and has a shape excluding corners. Specifically, in the recess 31B, in the cross sectional view in the Y-axis direction, each of boundaries 36 between the upper surface 31a and the two side surfaces 31b and 31c is formed not by a substantially right-angled corner, but by a curved surface.

In the recording head 1B according to the present embodiment described above as well, the pressure inside the holding portion 35 when the vibration plate 50 is in the abnormal displacement state is 1.05 times or more of the maximum pressure inside the holding portion 35 when the vibration plate 50 is in the normal displacement state, as a result of which, even when the vibration plate 50 is in the abnormal displacement state, breakage of the vibration plate 50 and the piezoelectric actuator 300 can be suppressed.

In addition, the inner surface of the recess 31B, which becomes the holding portion 35, includes a curve as described above and has a shape excluding corners, as a result of which, when the vibration plate 50 is in the abnormal displacement state, the pressure inside the holding portion 35 easily increases. Accordingly, even when the vibration plate 50 is in the abnormal displacement state, breakage of the vibration plate 50 and the piezoelectric actuator 300 can be more reliably suppressed. Moreover, since the rigidity of the protection substrate 30 corresponding to the wall portion of the holding portion 35 is enhanced, breakage of the protection substrate 30 due to stress in a bonding process can be suppressed.

### Fourth Embodiment

FIG. 11 is a cross sectional view of a recording head according to a fourth embodiment and is a cross sectional view taken along line XI-XI of FIG. 2. Note that the same members are denoted by the same reference numerals, and redundant descriptions are omitted.

In a recording head 1C according to the present embodiment as well, the shape of a recess 31C formed by the protection substrate 30 is a modification of the shape of the holding portion 35, which is a sealing space, and the configuration other than the shape of the recess 31C is the same as the configuration of the first embodiment.

As illustrated in FIG. 11, in the present embodiment, the inner surface of the recess 31C formed by the protection substrate 30 is formed into a curved shape in a cross sectional view in the Y-axis direction, which is the arrangement direction of the pressure chambers 12. Specifically, in the cross sectional view in the Y-axis direction, the inner surface of the recess 31C is formed into a substantially semi-elliptic shape. Needless to say, the inner surface of the recess 31C is not limited to a semi-elliptic shape as long as it is formed by a curve, and may be, for example, a substantially semicircular shape and the like.

In the recording head 1C according to the present embodiment described above as well, the pressure inside the holding portion 35 when the vibration plate 50 is in the abnormal displacement state is 1.05 times or more of the maximum pressure inside the holding portion 35 when the vibration plate 50 is in the normal displacement state, as a result of which, even when the vibration plate 50 is in the abnormal displacement state, breakage of the vibration plate 50 and the piezoelectric actuator 300 can be suppressed.

In addition, the inner surface of the recess 31C, which becomes the holding portion 35, has a curved shape as described above, as a result of which, when the vibration plate 50 is in the abnormal displacement state, the pressure inside the holding portion 35 easily increases.

Accordingly, even when the vibration plate 50 is in the abnormal displacement state, breakage of the vibration plate 50 and the piezoelectric actuator 300 can be more reliably suppressed. Moreover, since the rigidity of the entire protection substrate 30 is enhanced, breakage of the protection substrate 30 due to stress in a bonding process can be suppressed.

### Fifth Embodiment

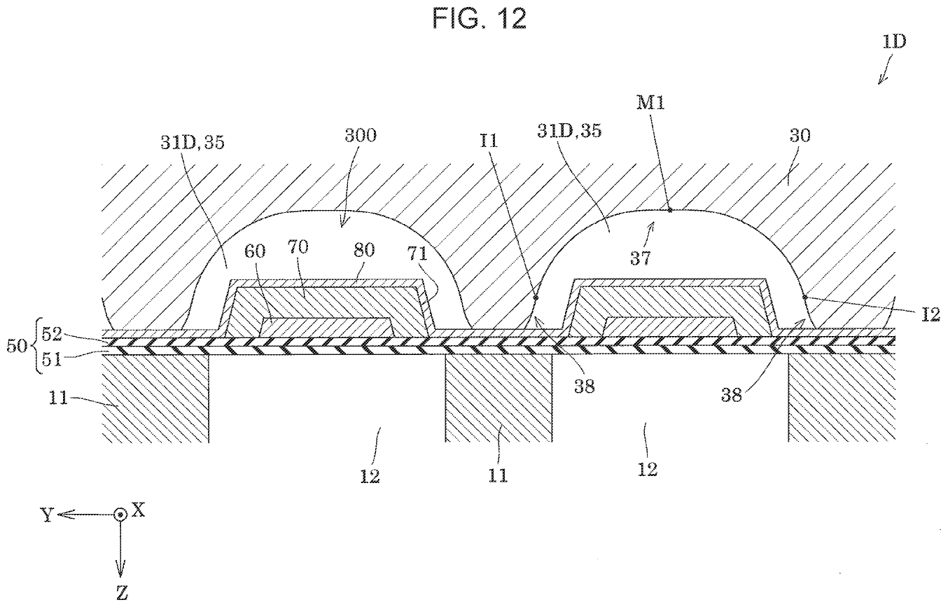

FIG. 12 is a cross sectional view of a recording head according to a fifth embodiment and is a cross sectional view taken along line XII-XII of FIG. 2. Note that the same members are denoted by the same reference numerals, and redundant descriptions are omitted.

In a recording head 1D according to the present embodiment, the shape of a recess 31D formed by the protection substrate 30 is a modification of the shape of the holding portion 35, which is a sealing space, and the configuration other than the shape of the recess 31D is the same as the configuration of the first embodiment.

As illustrated in FIG. 12, in the present embodiment, the inner surface of the recess 31D formed by the protection substrate 30 is formed into a curved shape having one extreme value M1 and two inflection points I1 and I2 in a cross sectional view in the Y-axis direction, which is the arrangement direction of the pressure chambers 12. In other words, the inner surface of the recess 31D is constituted by a first curve 37, which is a curve protruding on the outer side of the holding portion 35, and two second curves 38, which are provided on both sides of the first curve 37 and protrude on the inner side of the holding portion 35. That is, the inner surface of the recess 31D is formed into a curved shape approximating the shape of the vibration plate 50 when the vibration plate 50 is in the abnormal displacement state.

In the recording head 1D according to the present embodiment described above as well, the pressure inside the holding portion 35 when the vibration plate 50 is in the abnormal displacement state is 1.05 times or more of the maximum pressure inside the holding portion 35 when the vibration plate 50 is in the normal displacement state, as a result of which, even when the vibration plate 50 is in the abnormal displacement state, breakage of the vibration plate 50 and the piezoelectric actuator 300 can be suppressed.

In addition, the inner surface of the recess 31D has a curved shape having one extreme value M1 and two inflection points I1 and I2 as described above, as a result of which, when the vibration plate 50 is in the abnormal displacement state, the pressure inside the holding portion 35 easily increases. Accordingly, even when the vibration plate 50 is in the abnormal displacement state, breakage of the vibration plate 50 and the piezoelectric actuator 300 can be more reliably suppressed. Moreover, since the rigidity of the protection substrate 30 corresponding to the wall portion of the holding portion 35 is enhanced, breakage of the protection substrate 30 due to stress in a bonding process can be suppressed.

### Other Embodiments

Each embodiment of the present disclosure has been described thus far, but the basic configuration of the present disclosure is not limited to the configurations described above.

For example, in each embodiment described above, the first electrode 60 constitutes an individual electrode for each active portion, and the second electrode 80 constitutes an electrode common to a plurality of active portions, but the first electrode 60 may constitute an electrode common to a plurality of active portions, and the second electrode 80 may constitute an individual electrode for each active portion. Even in this case, the same effect as the embodiments described above can be obtained.

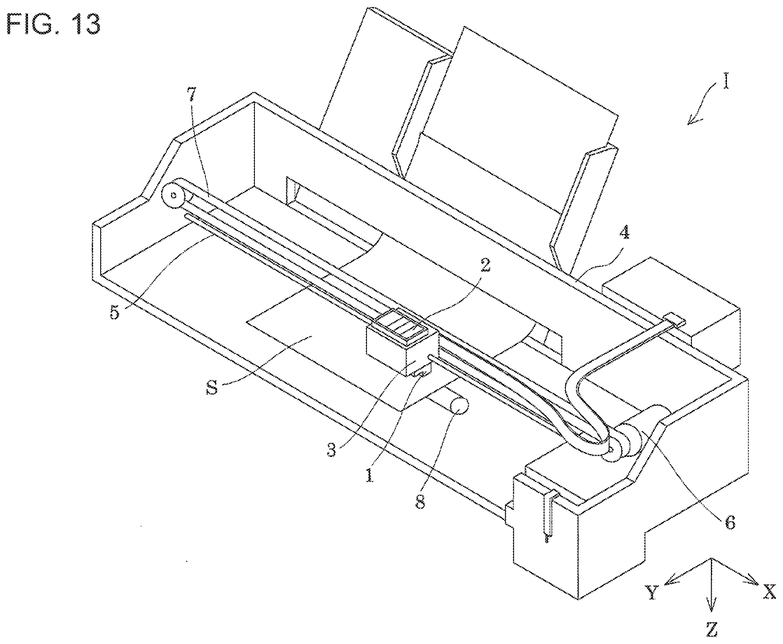

Moreover, the recording head 1 of each embodiment is mounted on an ink jet recording apparatus, which is an example of a liquid ejecting apparatus. FIG. 13 is a schematic view illustrating an example of an ink jet recording apparatus, which is an example of a liquid ejecting apparatus according an embodiment.

In an ink jet recording apparatus I illustrated in FIG. 13, the recording head 1, in which a cartridge 2 constituting an ink supply unit is detachably provided, is mounted on a carriage 3. The carriage 3, on which the recording head 1 is mounted, is provided so as to be movable in an axis direction of a carriage shaft 5 attached to an apparatus main body 4.

The driving power of a driving motor 6 is transferred to the carriage 3 via a plurality of gears (not illustrated) and a timing belt 7, as a result of which the carriage 3, on which the recording head 1 is mounted, is moved along the carriage shaft 5. On the other hand, the apparatus main body 4 is provided with a transporting roller 8 as a transporting unit, and a recording sheet S as a recording medium such as paper is transported by the transporting roller 8. Note that the transporting unit that transports the recording sheet S is not limited to the transporting roller 8 and may be a belt, a drum, or the like.

In the ink jet recording apparatus I described above, while the recording sheet S is transported in the +X-axis with respect to the recording head 1, the carriage 3 is caused to reciprocate in the Y-axis direction with respect to the recording sheet S, and ink droplets are ejected from the recording head 1, as a result of which ink droplet impacting, so-called printing, is executed over a substantially entire surface of the recording sheet S.

In addition, as the ink jet recording apparatus I described above, a configuration, in which the recording head 1 is mounted on the carriage 3 and reciprocates in the Y-axis direction, which is the main scanning direction, has been exemplified, but the present disclosure is not limited thereto. For example, the present disclosure can also be applied to a so-called line recording apparatus, in which the recording head 1 is fixed and only the recording sheet S such as paper is caused to move in the X-direction, which is the sub scanning direction, to perform printing.

Note that, in the above-mentioned embodiment, an ink jet recording head as an example of a liquid ejecting head and an ink jet recording apparatus as an example of a liquid ejecting apparatus have been described, but the present disclosure is widely applicable to all liquid ejecting heads and liquid ejecting apparatuses and, needless to say, is also applicable to a liquid ejecting head and a liquid ejecting apparatus that eject liquid other than ink. Examples of the liquid ejecting head that ejects liquid other than ink include various recording heads used for an image recording apparatus such as a printer, a color material ejecting head used for manufacturing a color filter such as a liquid crystal display, an electrode material ejecting head used for electrode formation such as an organic electro-luminescence (EL) display and a field emission display (FED), a bioorganic substance ejecting head used for manufacturing a biochip, and the like, and the present disclosure is also applicable to a liquid ejecting apparatus including such a liquid ejecting head.

What is claimed is:

1. A liquid ejecting head comprising:
a channel formation substrate provided with a plurality of pressure chambers communicating with a nozzle;
a vibration plate provided on one surface side of the channel formation substrate;
a piezoelectric actuator provided on a surface of the vibration plate on a side opposite to the channel formation substrate and facing each of the plurality of pressure chambers, and having a piezoelectric laminate, and a first electrode and a second electrode sandwiching the piezoelectric laminate; and
a protection substrate provided on one surface side of the channel formation substrate and including a recess, for the each pressure chamber, serving as a sealing space that seals the piezoelectric actuator inside, wherein,
as the piezoelectric actuator is driven, the vibration plate is displaced between a first position where the pressure chamber contracts to a maximum degree and a second position where the pressure chamber expands to a maximum degree, and droplets are ejected from the nozzle, and
in an abnormal displacement state where the vibration plate exceeds the second position and is displaced to a third position, and a displacement amount from a fourth position that is a center between the first position and the second position to the third position is twice or more of a displacement amount from the fourth position to the second position, pressure of the sealing space is 1.05 times or more of pressure of the sealing space when the vibration plate is at the second position.

2. The liquid ejecting head according to claim 1, wherein
pressure of the sealing space in the abnormal displacement state is 1.1 times or more of pressure of the sealing space when the vibration plate is at the second position.

3. The liquid ejecting head according to claim 1, wherein
the third position is a position when the vibration plate is bent as a protrusion on a side of the protection substrate and is on the side of the protection substrate from the channel formation substrate.

4. The liquid ejecting head according to claim 1, wherein
a height of a portion of the sealing space corresponding to the piezoelectric actuator is equal to or less than 10 μm.

5. The liquid ejecting head according to claim 4, wherein
a height of a portion of the sealing space corresponding to the piezoelectric actuator is equal to or less than 4 μm.

6. The liquid ejecting head according to claim 1, wherein
the vibration plate is bent as a protrusion on a side of the pressure chamber when the piezoelectric actuator is not driven.

7. The liquid ejecting head according to claim 1, wherein
pressure of the sealing space when the piezoelectric actuator is not driven is higher than 1 atmospheric pressure.

8. The liquid ejecting head according to claim 1, wherein
an inner surface of the recess provided in the protection substrate has a polygonal shape in a cross sectional view in an arrangement direction of the pressure chambers.

9. The liquid ejecting head according to claim 1, wherein
an inner surface of the recess provided in the protection substrate includes a curve and does not have a corner in a cross sectional view in an arrangement direction of the pressure chambers.

10. The liquid ejecting head according to claim 9, wherein
an inner surface of the recess provided in the protection substrate has a curved shape in a cross sectional view in an arrangement direction of the pressure chambers.

11. The liquid ejecting head according to claim 10, wherein
an inner surface of the sealing space provided in the protection substrate has a curved shape having one extreme value and two inflection points in a cross sectional view in an arrangement direction of the pressure chambers.

12. A liquid ejecting apparatus comprising the liquid ejecting head according to claim 1.
